(19) United States
(12) Patent Application Publication
(10) Pub. No.: US 2006/0222776 A1
(43) Pub. Date: Oct. 5, 2006

(54) Environment-resistant platinum aluminide coatings, and methods of applying the same onto turbine components

(75) Inventors: Murali N. Madhava, Chandler, AZ (US); Yiping Hu, Greer, SC (US); Derek Raybould, Denville, NJ (US); Trinh-Le Huu-Duc, Hampstead (CA); Siu-Ching D. Lui, Watchung, NJ (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/093,334

(22) Filed: Mar. 29, 2005

(51) Int. Cl. H05H 1/26; C23C 4/00; B05D 3/02; B05D 7/00

(52) U.S. Cl. 427/446; 427/372.2; 427/421.1; 427/402

(57) ABSTRACT

In a method for coating a surface of a turbine component with an environment-resistant aluminide, a coating is formed by cold gas-dynamic spraying a powder material on the turbine component surface, the powder material comprising aluminum, platinum, and at least one additional metal selected from the group consisting of nickel, chromium, hafnium, silicon, yttrium, rhenium, zirconium, cobalt, and tantalum. After forming the coating, at least one thermal diffusion treatment is performed on the turbine component to metallurgically homogenize the coating and thereby form an aluminide coating that includes by weight about 12 to about 30% aluminum, up to about 50% platinum, about 2 to about 25% chromium, about 1 to about 5% hafnium, about 1 to about 5% silicon, about 0.1 to about 1% yttrium, and about 1 to about 3% Zr, and nickel.

### TECHNICAL FIELD

The present invention relates to turbine engine components that function in high temperature and high pressure environments. More particularly, the present invention relates to methods for coating turbine engine components such as turbine blades and vanes to prevent erosion due to corrosion, oxidation, thermal fatigue, and other hazards.

### BACKGROUND

Turbine engines are used as the primary power source for various aircraft applications. The engines are also auxiliary power sources that drive air compressors, hydraulic pumps, and industrial gas turbine (IGT) power generation. Further, the power from turbine engines is used for stationary power supplies such as backup electrical generators for hospitals and the like.

Most turbine engines generally follow the same basic power generation process. Compressed air is mixed with fuel and burned, and the expanding hot combustion gases are directed against stationary turbine vanes in the engine. The vanes turn the high velocity gas flow partially sideways to impinge on the turbine blades mounted on a rotatable turbine disk. The force of the impinging gas causes the turbine disk to spin at high speed. Jet propulsion engines use the power created by the rotating turbine disk to draw more ambient air into the engine and the high velocity combustion gas is passed out of the gas turbine aft end to create forward thrust. Other engines use this power to turn one or more propellers, electrical generators, or other devices.

Since turbine engines provide power for many primary and secondary functions, it is important to optimize both the engine service life and the operating efficiency. Although hotter combustion gases typically produce more efficient engine operation, the high temperatures create an environment that promotes oxidation or corrosion. For this reason, many coatings and coating methods have been developed to increase the operating temperature limits and service lives of the high pressure turbine components, including the turbine blade and vane airfoils.

Current airfoil coatings include nickel aluminide, platinum modified nickel aluminide, and active element-modified aluminide and MCrAlY overlays. Such coatings are applied onto surfaces of turbine blades, vanes, and other components to protect against oxidation and corrosion attack. A number of methods such as pack aluminide, chemical vapor deposition, electron beam physical vapor deposition, high velocity oxy-fuel, and low pressure plasma spray are used to apply such coatings onto the hardware surfaces. These methods are often used in conjunction with additional complex procedures in order for the aluminide compositions to form environment-resistant coatings. For example, a typical platinum modified aluminide composition application includes plating platinum to a thickness of about 5 microns, followed by a heat treatment, a pack process or chemical vapor deposition aluminiding step, and another subsequent diffusion heat treatment. Methods such as those incorporating one or more chemical vapor deposition step may also require relatively expensive equipment.

Hence, there is a need for methods and materials for coating turbine engine components such as the turbine blades. There is a particular need for environment-resistant coating materials that will improve turbine component durability, and for efficient and cost effective methods of coating the components with such materials.

### BRIEF SUMMARY

The present invention provides a method for coating a surface of a turbine component with an environment-resistant aluminide. A coating is formed by cold gas-dynamic spraying a powder material on the turbine component surface, the powder material comprising aluminum, platinum, and at least one additional metal selected from the group consisting of nickel, chromium, hafnium, silicon, yttrium, rhenium, zirconium, cobalt, and tantalum. After forming the coating, a thermal diffusion treatment is performed on the turbine component at a temperature sufficiently high to metallurgically homogenize the coating and thereby form an aluminide modified with one or more reactive elements.

In another method for coating a surface of a turbine component with an environment-resistant aluminide, the turbine component is plated with at least one metal material. After plating the turbine component, a coating is formed over the plating by cold gas-dynamic spraying a powder material on the plated turbine component surface, the powder material comprising aluminum, platinum, and at least one additional metal selected from the group consisting of nickel, chromium, hafnium, silicon, yttrium, rhenium, zirconium, cobalt, and tantalum. After forming the coating, a thermal diffusion treatment is performed on the turbine component at a temperature sufficiently high to metallurgically homogenize the plating and the coating and thereby form an aluminide coating modified with one or more reactive elements.

In yet another method for coating a surface of a turbine component with an environment-resistant aluminide, a first coating is applied by cold gas-dynamic spraying a first powder material on the turbine component surface, the first powder material comprising aluminum, platinum, and at least one additional metal selected from the group consisting of nickel, chromium, hafnium, silicon, yttrium, rhenium, zirconium, cobalt, and tantalum. After forming the first coating, a second coating is applied by cold gas-dynamic spraying a second powder material on the first coating, the second powder material comprising aluminum, platinum, and at least one additional metal selected from the group consisting of nickel, chromium, hafnium, silicon, yttrium, rhenium, zirconium, cobalt, and tantalum. After forming the second coating, a thermal diffusion treatment is performed on the turbine component at a temperature sufficiently high to convert the first and second coatings to a substantially homogenous aluminide that includes by weight about 12 to about 30% aluminum, up to about 50% platinum, about 2 to about 25% chromium, about 0.1 to about 5% hafnium, about 1 to about 5% silicon, about 0.1 to about 3% yttrium, about 0.1 to about 3% Zr, and nickel.

Other independent features and advantages of the preferred methods will become apparent from the following detailed description, taken in conjunction with the accompanying drawings which illustrate, by way of example, the principles of the invention.

### BRIEF DESCRIPTION OF THE DRAWINGS

FIG. 1 is a schematic view of an exemplary cold gas-dynamic spray apparatus in accordance with the present invention;

FIG. 2 is a perspective view of a turbine blade;

FIG. 3 is a flow diagram of an exemplary coating method in accordance with the present invention;

FIG. 4 is a flow diagram of a second exemplary coating method in accordance the present invention; and

FIG. 5 is a flow diagram of a third exemplary coating method in accordance the present invention.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

The present invention provides an improved method for coating high pressure turbine (HPT) components such as turbine blades and vanes to prevent degradation due to corrosion, oxidation, thermal fatigue, and other hazards. The method utilizes a cold gas-dynamic spray technique to coat turbine component surfaces with aluminum, nickel, platinum, chromium, hafnium, silicon, yttrium, and other metals. A thermal diffusion treatment, such as inert atmospheric treatment in argon, a vacuum heat treatment or a hot isostatic pressing, follows the cold gas-dynamic spray technique to form aluminides such as nickel/platinum aluminide coatings modified with one or more reactive elements. In comparison with conventional aluminide coating methods, the present invention provides a simple, economical, and efficient process.

Turning now to FIG. 1, an exemplary cold gas-dynamic spray system 100 is illustrated diagrammatically. The system 100 is illustrated as a general scheme, and additional features and components can be implemented into the system 100 as necessary. The main components of the cold-gas-dynamic spray system 100 include a powder feeder for providing powder materials, a carrier gas supply (typically including a heater) for heating and accelerating powder materials, a mixing chamber and a convergent-divergent nozzle. In general, the system 100 transports the powder mixtures with a suitable pressurized gas to the mixing chamber. The particles are accelerated by the pressurized carrier gas, such as air, helium, nitrogen, or mixtures thereof, through the specially designed nozzle and directed toward a targeted surface on the turbine component. When the particles strike the target surface, converted kinetic energy causes plastic deformation of the particles, which in turn causes the particles to form a bond with the target surface and to cohere with the solid splats previously and subsequently bonded to the target surface. Thus, the cold gas-dynamic spray system 100 can bond the powder materials to an HPT component surface and thereby form a protective coating on the component.

The cold gas dynamic spray process is referred to as a “cold spray” process because the particles are applied at a temperature that is well below their melting point. The kinetic energy of the particles on impact with the target surface, rather than particle temperature, causes the particles to plastically deform and bond with the target surface and to cohere with the solid splats previously and subsequently bonded to the target surface. Therefore, bonding to the HPT component surface, as well as deposition buildup, takes place as a solid state process with insufficient thermal energy to transition the solid powders to molten droplets.

According to the present invention, the cold gas-dynamic spray system 100 applies a powder, including elemental and/or alloyed metals, which are subsequently heat treated to form aluminide compounds that are modified with one or more reactive elements. The cold gas-dynamic spray system 100 can deposit multiple layers of different metals, densities, and strengths. The system 100 is typically operable in an ambient external environment.

The cold gas-dynamic spray system 100 is useful to spray a variety of powdered metals. In an exemplary embodiment, the powder includes aluminum, at least one precious metal selected from the group consisting of platinum, palladium, rhodium, and iridium, and at least one additional metal selected from the group consisting of nickel, chromium, hafnium, silicon, yttrium, rhenium, zirconium, cobalt, and tantalum. All of these metals can be provided as substantially pure elemental powders, or as alloys of one or more metals. Some non-limiting examples of metal alloy or metal alloy/metal powder combinations that suitably undergo plastic deformation during the cold gas-dynamic spray process include AlPtHfY, one or more alloys of PtNiCrCo plus one or more alloys of AlHfSiY, one or more alloys of PtNiCrCoHfSiY plus Al, and one or more alloys of PtNiCrCoHfY alloy plus one or more alloys of AiSi. Also, a completely pre-alloyed composition can be utilized. In these and other embodiments, platinum can be replaced with another precious metal such as palladium. Following the cold gas-dynamic spraying and at least one subsequent thermal diffusion treatment, an exemplary aluminide coating includes by weight about 12 to about 30% aluminum, up to about 50% platinum, about 2 to about 25% chromium, about 0.1 to about 5% hafnium, about 1 to about 5% silicon, about 0.1 to about 3% yttrium, and about 0.1 to about 3% Zr, and nickel.

The powder may be pre-alloyed, so that all of the elements are uniformly distributed within each powder particle, or powders of each separate element may be simply mixed together in the required ratio. Both approaches have advantages. For example, admixed powder is much less expensive than prealloyed powder. However, in some cases one or more metals may be explosive, costly, or otherwise hazardous or inefficient to handle in a relatively pure form. In such a case, safety or economic concerns would favor a prealloyed powder that only contains a small percentage of such metals.

As previously mentioned, the cold gas-dynamic spray process can be used to provide a protective coating on a variety of different turbine engine components. For example, the turbine blades in the hot section of a turbine engine are particularly susceptible to wear, oxidation and other degradation. One exemplary turbine blade that is coated according to the present invention is made from high performance Ni-based superalloys such as IN738, IN792, MarM247, C101, Rene 80, Rene 125, Rene N5, SC 180, CMSX 4, and PWA 1484.

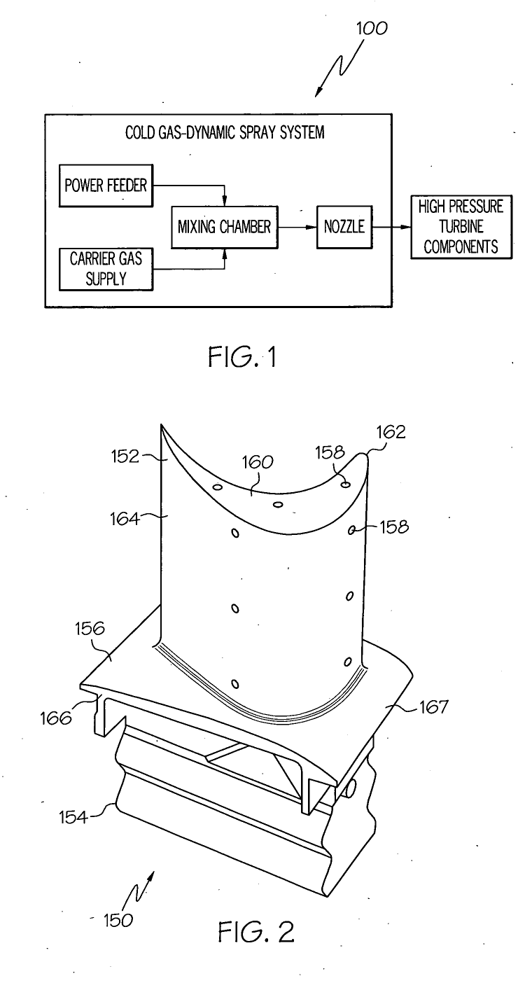

Turning now to FIG. 2, a blade 150 that is exemplary of the types that are used in turbine engines is illustrated, although turbine blades commonly have different shapes, dimensions and sizes depending on gas turbine engine models and applications. The blade 150 includes several components that are particularly susceptible to erosion, wear, oxidation, corrosion, cracking, or other damage, and the process of the present invention can be tailored to coat different blade components. Among such blade components is an airfoil 152. The airfoil 152 includes a concave face and a convex face. In operation, hot gases impinge on the concave face and thereby provide the driving force for the turbine engine. The airfoil 152 includes a leading edge 162 and a trailing edge 164 that encounter air streaming around the airfoil 152. The blade 150 also includes a tip 160. In some applications the tip may include raised features commonly known as squealers. The turbine blade 150 is mounted on a non-illustrated turbine hub or rotor disk by way of a dovetail 154 that extends downwardly from the airfoil 152 and engages with a slot on the turbine hub. A platform 156 extends longitudinally outwardly from the area where the airfoil 152 is joined to the dovetail 154. A number of cooling channels desirably extend through the interior of the airfoil 152, ending in openings 158 in the surface of the airfoil 152.

As mentioned previously, the process of the present invention can be tailored to fit the blade's specific needs, which depend in part on the blade component where degradation has occurred. For example, the airfoil tip 160 is particularly subject to degradation due to oxidation, erosion, thermal fatigue and wear, and the cold gas dynamic spray process is used to apply the mixture of metal powders onto a new or refurbished airfoil tip 160. As another example, degradation resistance on the airfoil leading edge 162 can be improved using the cold gas-dynamic spray process. The leading edge 162 is subject to degradation, typically due to erosion and foreign particle impact. In this application, the cold gas dynamic spray process is used to apply materials that protect anew or refurbished leading edge 162. Again, this can be done by cold gas-dynamic spraying the metal powders onto the leading edge 162. The cold spraying is followed by at least one heat treatment and any other necessary post-spray processing.

It is also emphasized again that turbine blades are just one example of the type of turbine components that can be coated using a cold gas-dynamic spray process. Vanes, shrouds, combustion liners, and other turbine components can be coated in a similar manner according to the present invention.

A variety of different systems and implementations can be used to perform the cold gas-dynamic spraying process. For example, U.S. Pat. No. 5,302,414, entitled “Gas-Dynamic Spraying Method for Applying a Coating” and incorporated herein by reference, describes an apparatus designed to accelerate materials having a particle size of between 5 to about 50 microns, and to mix the particles with a process gas to provide the particles with a density of mass flow between 0.05 and 17 g/s-cm². Supersonic velocity is imparted to the gas flow, with the jet formed at high density and low temperature using a predetermined profile. The resulting gas and powder mixture is introduced into the supersonic jet to impart sufficient acceleration to ensure a particle velocity ranging between 300 and 1200 m/s. In this method, the particles are applied and deposited in the solid state, i.e., at a temperature which is considerably lower than the melting point of the powder material. The resulting coating is formed by the impact and kinetic energy of the particles which gets converted to high-speed plastic deformation, causing the particles to bond to the surface. The system typically uses gas pressures of between 5 and 20 atm, and at a temperature of up to 750° F. As non limiting examples, the gases can comprise air, nitrogen, helium and mixtures thereof. Again, this system is but one example of the type of system that can be adapted to cold spray powder materials to the target surface.

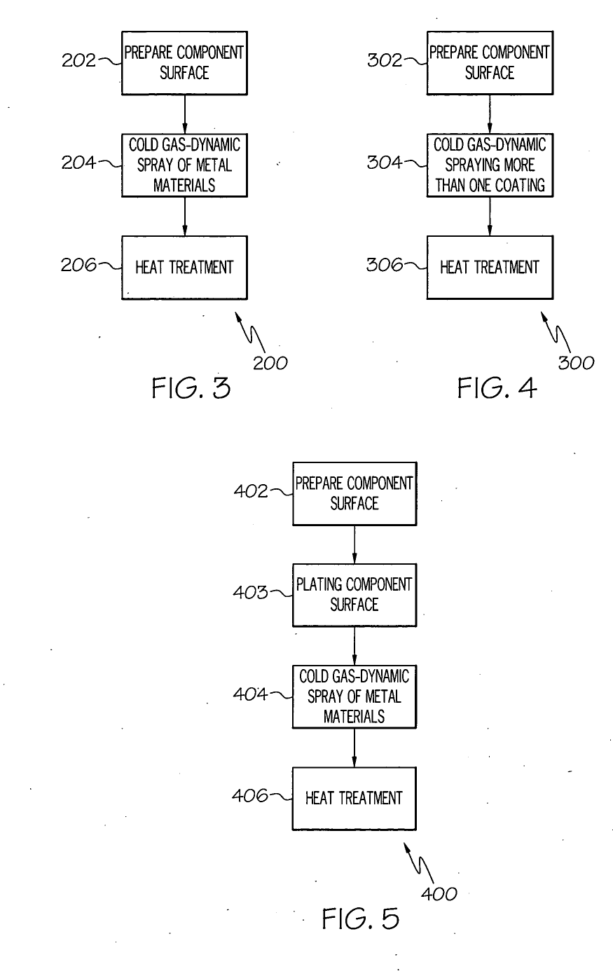

Turning now to FIG. 3, an exemplary method 200 is illustrated for coating and protecting turbine blades, vanes, and other turbine components. This method includes the cold gas-dynamic spray process described above, and also includes a diffusion heat treatment. As described above, cold gas-dynamic spray involves “solid state” processes to effect bonding and coating build-up, and does not rely on the application of external thermal energy for bonding to occur. However, thermal energy is provided after bonding has occurred since thermal energy promotes formation of the desired microstructure and phase distribution for the cold gas-dynamic sprayed metal powders, and consequently consolidates and homogenizes the metal aluminide coating.

The first step 202 comprises preparing the surface on the turbine component. For example, the first step of preparing a turbine blade can involve tip rebuild, pre-machining, degreasing and grit blasting the surface to be coated in order to remove any oxidation or contamination.

The next step 204 comprises performing a cold gas-dynamic spray of elemental and/or alloyed metal powders on the turbine component. As described above, in cold gas-dynamic spraying, particles at a temperature below their melting temperature are accelerated and directed to a target surface on the turbine component. When the particles strike the target surface, the kinetic energy of the particles is converted into plastic deformation of the particle, causing the particles to form a strong bond with the target surface. The spraying step includes directly applying the powder to turbine components in the turbine engine. For example, material can be applied to airfoil surfaces on turbine blades and vanes in general, and particularly to blade tips and leading edges for local repair, for example. The spraying step 204 generally returns the component to its desired dimensions, although additional machining can be performed if necessary to accomplish dimensional restoration.

The next step 206 involves performing a thermal diffusion treatment on the coated turbine component. A thermal diffusion treatment generates and homogenizes the microstructure of coating and greatly improves the coating performance and the bonding strength between the coating and the substrate. The thermal treatment may be applied in a high temperature furnace using a vacuum or an inert or other protective gas to avoid oxidation. One exemplary thermal diffusion treatment is performed in an inert atmosphere or under vacuum, with controlled temperature ramps to reach coating formation temperatures between 1850° F. and 2050° F. Another exemplary thermal diffusion treatment is a hot isostatic pressing treatment. One possible hot isostatic pressing treatment is performed for about 2 to about 4 hours at a temperature between about 2050° F. and about 2250° F., and at a pressure between about 15 ksi to about 30 ksi. These and other exemplary thermal treatments can also be used in combination.

FIG. 4 is a flow diagram of another exemplary method 300 for coating and protecting turbine blades, vanes, and other turbine components. This method includes multiple cold gas-dynamic spray processes. Step 302, directed to surface preparation, is identical to step 202 described in detail above. Likewise, step 306, directed to a thermal diffusion treatment, is identical to previously described step 206.

Step 304 comprises forming a plurality of coatings by cold gas-dynamic spraying different mixtures of metal powders on the turbine component. In some cases it is advantageous to spray a powder that includes one or more elements or specific alloys before spraying other elements or alloys onto the turbine component. Since cold gas-dynamic spraying entails application of particles at a temperature well below their melting temperature, process parameters for individual elements or alloys may vary in order for all of the particles to undergo sufficient plastic deformation and thereby uniformly bond to a target surface. Thus, an exemplary multiple-step cold gas-dynamic spraying procedure employs a first powder and/or velocity parameter during a first spraying step, followed by a second powder and/or velocity parameter during a second spraying step, and so forth.

FIG. 5 is a flow diagram of another exemplary method 400 for coating and protecting turbine blades, vanes, and other turbine components. This method includes a plating process 403 that is performed before a cold gas-dynamic spray process 404. Step 402, directed to surface preparation, is identical to steps 202 and 302 described in detail above. Likewise, step 406, directed to a thermal diffusion treatment, is identical to previously described steps 206 and 306.

Step 403 includes at least one plating process that is performed to apply one or more layers of an element or an alloy onto the turbine component surface before performing one or more cold gas-dynamic spray process. An exemplary plating process includes electroplating a layer of a precious noble metal such as platinum, palladium, rhodium, or iridium directly onto the turbine component surface. An exemplary alloy that is subsequently cold sprayed onto the plating is AlHfYZr. The plating process can be followed by an optional low temperature treatment at about 1110° F. (600° C.) to improve platinum bonding, or other precious noble metal bonding, to the substrate. An alternative optional heat treatment to diffuse a platinum plating into the substrate can be performed in the temperature range of 1800° F. to 2000° F. to form a predominantly nickel-platinum solid solution layer at the surface. Platinum alloys, as well as pure platinum, are relatively expensive materials to obtain in powder form. Therefore, under this approach the overall procedure can be performed at a relatively low cost by performing at least one plating process 403 with an optional thermal bonding and/or diffusion treatment, followed by at least one cold gas-dynamic spray process 404, and then performing a thermal diffusion treatment on the coated turbine component to homogenize the microstructure of the plating layers and the subsequently formed coating layers.

The present invention thus provides an improved method for coating turbine engine components. The method utilizes a cold gas-dynamic spray technique to prevent degradation in turbine blades and other turbine engine components. These methods can be used to optimize the operating efficiency of a turbine engine, and to prolong the service life of turbine blades and other engine components.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed herein as the best mode contemplated for carrying out this invention, but that the invention will include all embodiments falling within the scope of the appended claims.

We claim:

1. A method for coating a surface of a turbine component with an environment-resistant aluminide, comprising the step of:
forming a coating by cold gas-dynamic spraying a powder material on the turbine component surface, the powder material comprising aluminum, platinum, and at least one additional metal selected from the group consisting of nickel, chromium, hafnium, silicon, yttrium, rhenium, zirconium, cobalt, and tantalum; and
performing at least one thermal diffusion treatment to metallurgically homogenize the coating and thereby form an aluminide coating.

2. The method of claim 1, wherein the powder material is prealloyed.

3. The method of claim 1, wherein the powder material comprises a mixture of elemental metal powders.

4. The method of claim 1, wherein the at least one thermal diffusion treatment is one or more treatments selected from the group consisting of a hot isostatic pressing process, a vacuum heat treatment, and a heat treatment performed in an inert atmosphere.

5. The method of claim 4, wherein the aluminide comprises by weight about 12 to about 30. % aluminum, up to about 50% platinum, about 2 to about 25% chromium, about 0.1 to about 5% hafnium, about 1 to about 5% silicon, about 0.1 to about 3% yttrium, and about 0.1 to about 3% Zr, and nickel.

6. The method of claim 1, wherein the turbine component is a turbine blade.

7. The method of claim 1, wherein the turbine component is a turbine vane.

8. A method for coating a surface of a turbine component with an environment-resistant aluminide, comprising the steps of:
plating the turbine component with at least one metal material;
forming a coating over the plating by cold gas-dynamic spraying a powder material on the plated turbine component surface, the powder material comprising aluminum, and at least one additional metal selected from the group consisting of nickel, platinum, chromium, hafnium, silicon, yttrium, rhenium, zirconium, cobalt, and tantalum; and
performing at least one thermal diffusion treatment to metallurgically homogenize the coating and thereby form an aluminide coating.

9. The method of claim 8, wherein the plating step is an electroplating process followed by a low temperature heat treatment.

10. The method of claim 8, wherein the at least one metal material applied by the plating step comprises a precious noble metal.

11. The method of claim 8, wherein the powder material is pre-alloyed.

12. The method of claim 8, wherein the powder material comprises a mixture of elemental metal powders.

13. The method of claim 8, wherein the at least one thermal diffusion treatment is one or more treatments selected from the group consisting of a hot isostatic pressing process, a vacuum heat treatment, and a heat treatment performed in an inert atmosphere.

14. The method of claim 8, wherein the aluminide comprises by weight about 12 to about 30% aluminum, up to about 50% platinum, about 2 to about 25% chromium, about 0.1 to about 5% hafnium, about 1 to about 5% silicon, about 0.1 to about 3% yttrium, and about 0.1 to about 3% Zr, and nickel.

15. A method for coating a surface of a turbine component with an environment-resistant aluminide, comprising the steps of:
forming a first coating by cold gas-dynamic spraying a first powder material on the turbine component surface, the first powder material comprising at least one metal selected from the group consisting of nickel, aluminum, platinum, chromium, hafnium, silicon, yttrium, rhenium, zirconium, cobalt, and tantalum;
forming a second coating by cold gas-dynamic spraying a second powder material on the first coating, the second powder material comprising at least one metal selected from the group consisting of nickel, aluminum, platinum, chromium, hafnium, silicon, yttrium, rhenium, zirconium, cobalt, and tantalum; and
performing at least one thermal diffusion treatment to metallurgically homogenize the combined first and second coatings and thereby form an aluminide coating that comprises by weight about 12 to about 30% aluminum, up to about 50% platinum, about 2 to about 25% chromium, about 0.1 to about 5% hafnium, about 1 to about 5% silicon, about 0.1 to about 3% yttrium, and about 0.1 to about 3% Zr, and nickel.

16. The method of claim 15, wherein each of the first and second powder materials is prealloyed.

17. The method of claim 15, wherein each of the first and second powder materials comprises a mixture of elemental metal powders.

18. The method of claim 15, wherein the thermal diffusion treatment is one or more treatments selected from the group consisting of a hot isostatic pressing process, a vacuum heat treatment, and a heat treatment performed in an inert atmosphere.
